(19) United States
(12) Patent Application Publication
(10) Pub. No.: US 2004/0033375 A1
(43) Pub. Date: Feb. 19, 2004

(54) Thin-film layer, method for forming a thin-film layer, thin-film layer fabrication apparatus and thin-film device

(76) Inventor: Hiroshi Mori, Los Angeles, CA (US)

Correspondence Address: BACHMAN & LAPOINTE, P.C., 900 CHAPEL STREET, SUITE 1201, NEW HAVEN, CT, 06510, US

(21) Appl. No.: 10/441,644

(22) Filed: May 20, 2003

Related U.S. Application Data
(63) Continuation-in-part of application No. 10/223,810, filed on Aug. 19, 2002.

(51) Int. Cl. B32B 27/00

(52) U.S. Cl. 428/457; 428/422.8

(57) ABSTRACT

A thin-film layer comprises a molecular and/or particle assembly layer defining a cured layer over an organic layer, and is formed by coating a substrate with a polymer solution based on one resin selected from the group consisting of acrylic resins, urethane resins, epoxy resins and the like, and further applying, onto the polymer solution, a polymer/particle mixture solution containing therein at least one particle selected from the group consisting of metal particles, organic particles, inorganic particles, colloidal particles and the like and then followed by exposing the polymer/particle mixture solution to light and/or heat, thereby inducing a crosslinking polymerization reaction in the polymer/particle mixture solution over the polymer solution for gelating the particles.

### BACKGROUND OF THE INVENTION

1. Field of the Invention

The present invention relates to a thin-film layer with a cured layer formed on its surface, a method for forming a thin-film layer, a thin-film layer fabrication apparatus, and a thin-film device. Further, the invention relates to a thin-film layer formed by using a prepared solution and photo-initiated polymerization, which then results in aggregation within the prepared solution.

2. Prior Art and Its Drawback

There are known methods for curing a material such as a macromolecule or a polymer and the like, by simply irradiating the material with a UV light. However, the cured surface layer of the traditional method lacks the capability of creating a nearly pure, and homogenous surface, and furthermore, lacks sufficient resistance to chemical attack, wear and weather damage.

### SUMMARY OF THE INVENTION

The invention addresses the above drawback of the prior art and has the objective to achieve sufficient resistance to chemical attack, wear, and weather damage, which cannot be attained by the prior-art coating method of which resin is cured by UV or electron beam radiation.

The object of this invention is fulfilled by forming a molecular and/or particle assembly layer over a organic layer cured by UV or electron beam radiation.

The thin-film layer according to the invention comprises a molecular and/or particle assembly layer defining a cured layer over an organic layer, and is formed by coating a substrate with a polymer solution based on one resin selected from the group consisting of acrylic resins, urethane resins, epoxy resins and the like, and further applying, onto the polymer solution, a polymer/particle mixture solution containing therein at least one particle selected from the group consisting of metal particles, organic particles, inorganic particles, colloidal particles and the like and then followed by exposing the polymer/particle mixture solution to light and/or heat, thereby inducing a crosslinking polymerization reaction in the polymer/particle mixture solution over the polymer solution for gelating the particles.

The thin-film layer according to the invention comprises a molecular and/or particle assembly layer defining a cured layer formed over the organic layer as a result of the exposure of the pre-polymer solution to light and/or heat inducing cross-linking polymerization reaction. A pre-polymer solution containing polymers, monomers, particles of the film layer and an initiator is first prepared in liquid state to allow a controlled photo-initiated polymerization.

Depending on the surface of the substrate, an initial base coat consisting of a polymer may have to be applied in order for the pre-polymer solution to create a strong cross-linking bond. This is usually not necessary for substrates that are synthetic polymers, such as film.

Once the pre-polymer solution has been applied, it is then cured with a UV light or electron beam. The irradiation will cause the photo-initiators in the pre-polymer solution to initiate an addition-polymerization reaction. This will result in the synthesis of graft copolymers with the original polymers and monomers, and induce a cross-linking polymerization reaction starting from the boundary of the substrate and pre-polymer, and result in a homogenous film layer remove on the top surface, which consists of the particle or element added to the pre-polymer solution. There are three factors that account to the reaction.

The addition-polymerization causes a decrease in volume of the pre-polymer solution due to solidification and cause the particles to diffuse to the surface, since there is no way to diffuse towards the substrate/pre-polymer border, which is cross-linked.

The polymer in their propagation stage helps to repel the particles to the surface using their charge.

An aggregation reaction occurs within the pre-polymer solution, which causes a separation of the graft copolymers, which have a hydrophobic characteristic and the particles. The copolymers will continue to polymerize with the surface, and the remaining particles will move or collect at the top layer, which becomes the new film layer on the top because of its lighter mass.

The thin-film layer according to the invention comprises a molecular and/or particle assembly layer defining a cured surface layer over an organic layer and is formed by coating a plastic substrate with a polymer/particle mixture solution containing therein at least one particle selected from the group consisting of metal particles, organic particles, inorganic particles, colloidal particles and the like and exposing the polymer/particle mixture solution to light and/or heat, thereby inducing crosslinking polymerization reaction in the mixture for gelating the particles.

Where the substrate is metallic, it is preferred to electrodeposit the polymer on the substrate. The polymer/particle mixture solution is irradiated with UV light or electron beam, and/or otherwise heated. In the UV radiation, the polymer solution is exposed to UV light rays of different wavelengths.

The substrate is selected from the group consisting of metals, ceramics, glass, wood, paper, plastics and the like. The polymer is based on one resin selected from the group consisting of acrylic resins, urethane resins, epoxy resins and the like, and serves as a base coat.

The polymer/particle mixture solution contains a photo-polymerizable prepolymer, a photo-polymerizable monomer, a photo-polymerization initiator and, as required, a metal particle, organic particle, inorganic particle, colloidal particle or the like.

The molecular and/or particle assembly layer comprises a metal oxide, inorganic oxide or amorphous substance. Otherwise, the molecular and/or particle assembly layer may comprise SiO₂ or amorphous silica.

In a case where the above molecular and/or particle assembly layer comprises SiO₂ or amorphous silica, the thin-film layer is adapted to provide a glass coating which is adequately applicable to metal articles such as road wheels of automobiles and the like.

When silica is chosen as the colloidal particle, a thin and homogenous thin film of a material similar to glass is formed at the surface.

When two or more particles are included in the pre-polymer solution, the reaction will result in two film layers, such as a silica layer on top of a silver layer.

In the fabrication of a printed wiring board which currently requires the known techniques of electrolytic plating, electroless plating, lamination and the like, the molecular and/or particle assembly layer defining the top layer of the thin-film layer can be formed from a conductive metal such as copper or the like.

The molecular and/ or particle assembly layer defining the top layer of the thin film layer can be also formed from a conductive metal such as copper or the like, which can be utilized to simplify fabrication of printed wiring boards from the complicated current techniques of electrolytic plating, electroless plating, lamination and the like. Therefore, it is possible to reconstruct discrete electrical components such as diodes, transistors, resistors, capacitors, semi-conductors, hybrid IC into a ‘thin film’ device, instead of the current form.

A gas barrier laminate or a protective laminate comprises an organic layer of a polymer and a polymer/particle mixture formed by coating the substrate with the polymer solution based on one resin selected from the group consisting of acrylic resins, urethane resins, epoxy resins and the like, and further applying, onto the polymer solution, the polymer/particle mixture solution containing therein at least one particle material selected from the group consisting of metal particles, organic particles, inorganic particles, colloidal particles and the like, followed by exposing the polymer/particle mixture solution to light and/or heat; and a plurality of molecular and/or particle assembly layers defining a cured layer is formed over the organic layer as a result of the exposure of the polymer/particle mixture solution to light and/or heat inducing crosslinking polymerization reaction in the polymer/particle mixture solution over the polymer solution for gelating the particles, wherein the assembly layers comprising at least one layer selected from the group consisting of non-particle layer, layer containing one particle and layer containing a plurality of different particles.

A gas barrier laminate or a protective laminate comprises an organic layer of a polymer and a polymer/particle mixture formed by coating the substrate with a pre-polymer solution containing polymers, monomers, particles and an initiator; and a plurality of molecular and/or particle assembly layers defining a cured layer is formed over the organic layer as a result of the exposure of the pre-polymer solution to light and/or heat inducing cross-linking polymerization reaction, wherein the assembly layers comprising at least one layer selected from the group consisting of non-particle layer, layer containing one particle and layer containing a plurality of different particles.

A gas barrier laminate or a protective laminate comprises an organic layer of a polymer and a polymer/particle mixture formed by coating the substrate with polymer/particle mixture solution applied over the substrate, the mixture solution containing therein at least one particle selected from the group consisting of metal particles, organic particles, inorganic particles, colloidal particles and the like; and a plurality of molecular and/or particle assembly layers defining a cured layer formed over an organic layer as a result of the exposure of the polymer/particle mixture solution to light and/or heat inducing crosslinking polymerization reaction in the mixture for gelating the particles, wherein the assembly layers comprising at least one layer selected from the group consisting of non-particle layer, layer containing one particle and layer containing a plurality of different particles.

The molecular and/or particle assembly layer defining a cured layer with the one or more different molecular and/or particle is formed by at least one particle selected from the group consisting of specific gravity of particle, size of particle, surface properties such as wettability or surface tension in the interface of polymer with particle, orientation of particle, interaction between particles, charge action of particle, migration by light irradiation such as UV light and/or heat of particle.

The size of particle is order of nanometer. The particle provides a conductive characteristic or dye characteristic.

A thin-film layer comprises an surface layer comprising a mixture of a silicon dioxide and a resin such as an acrylic resin of 2˜3 μm, the surface layer containing elements of carbon (C), oxygen (O) and silicon (Si), a strength relation between the elements in the surface layer being C=Si>O;

an inner layer comprising a resin such as an acrylic resin of several tens μm formed on a matrix of a metallic material such as aluminum, the inner layer containing elements of carbon (C), oxygen (O), silicon (Si), a strength relation between the elements being C>>O=Si.

A thin-film layer comprises an surface layer comprising a mixture of a silicon dioxide and a resin such as an acrylic resin of 2˜3 μm, the surface layer containing elements of carbon (C), oxygen (O) and silicon (Si), a strength relation between the elements in the surface layer being C=Si>O;

an inner layer comprising a resin such as an acrylic resin of several tens μm formed on a matrix of a metallic material such as aluminum, the inner layer containing elements of carbon (C), oxygen (O), silicon (Si), a strength relation between the elements being C>>O=Si; and

a fibrous substance being in the vicinity of the matrix in the inner layer, the fibrous substance having a length of several tens μm and a thickness of several μm and containing elements of carbon (C), oxygen (O) and an additive of a metal, a strength relation between the respective elements being the element of additive of metal>C>O.

A method for forming a thin-film layer comprises the steps of applying a polymer solution onto a metallic substrate of aluminum or the like, and then applying a polymer/particle mixture solution thereon, wherein the thin-film layer after the application is heated to 155° F. to 185° F., and then irradiated with an ultraviolet ray having a wavelength of 250 nm to 360 nm, an energy per unit area of the thin-film layer being at least 75 mJ/cm².

A thin-film layer fabrication apparatus for fabricating the thin-film layer according to the invention comprises: a chamber including a conveyor system for conveying a substrate, a coating applicator for applying, onto the substrate, a polymer solution based on one resin selected from the group consisting of acrylic resins, urethane resins, epoxy resins and the like, and a light/heat source for exposing a polymer/particle mixture solution to light or heat, the polymer/particle mixture solution comprising the polymer containing therein at least one particle selected from the group consisting of metal particles, organic particles, inorganic particles, colloidal particles and the like; and a filter for preventing the entrance of dusts and foreign substances into the chamber.

The light/heat source is a UV irradiation apparatus, electron beam irradiation apparatus and/or heat source. The UV irradiation apparatus emits UV light rays of different wavelengths The fabrication system further comprises a UV lamp adjustable device for permitting a UV lamp of the UV irradiation apparatus to be inclined at a predetermined angle. The fabrication system further comprises a cooling system for cooling the UV irradiation apparatus.

### BRIEF DESCRIPTION OF THE DRAWINGS

FIG. 1A is a sectional view showing a multi-layered stack for forming a thin-film layer according to the first embodiment of the invention;

FIG. 1B is a sectional view showing the thin-film layer according to the first embodiment of the invention;

FIG. 2A is a sectional view showing a multi-layered stack for forming a thin-film layer according to a second embodiment of the invention;

FIG. 2B is a sectional view showing the thin-film layer according to the second embodiment of the invention;

FIG. 3A is a sectional view showing a multi-layered stack for forming a thin-film layer according to a third embodiment of the invention;

FIG. 3B is a sectional view showing the thin-film layer according to the third embodiment of the invention;

FIG. 4 is a sectional view showing the main portion of an organic EL element in which a flexible metal plate is used for a drive circuit substrate;

FIG. 5 is a sectional view schematically showing a gas barrier laminate for package which is used in package-fields;

FIG. 6 is a sectional view showing a condition in which a thin-film layer regarding the present invention is deposited on an aluminum wheel attached to a tire of an automobile;

FIG. 7 is a strength relation between the elements in the inner layer an energy dispersion type X-ray analysis device (EDX);

FIG. 8 is a strength relation between the elements in the surface layer an energy dispersion type X-ray analysis device (EDX);

FIG. 9 is a strength relation between the elements in the fibrous substance surface layer an energy dispersion type X-ray analysis device (EDX); and

FIG. 10 schematically shows a fabrication apparatus for fabricating the thin-film layer.

### DESCRIPTION OF THE PREFERRED EMBODIMENTS

Now, preferred embodiments of the invention will hereinbelow be described with reference to the accompanying drawings.

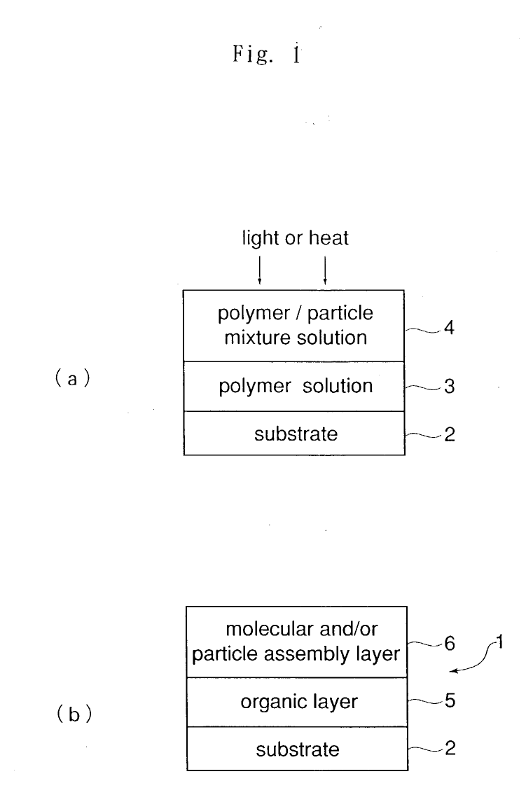

Referring to FIGS. 1A and 1B, a procedure of fabricating a thin-film layer 1 is described. First, a substrate 2 is prepared which is formed of one material selected from the group consisting of metals, ceramics, glass, wood, plastics, paper and the like. A polymer solution 3 based on one resin selected from the group consisting of acrylic resins, urethane resins, epoxy resins and the like is coated on the substrate 2. The polymer solution serves as a base coat layer.

A polymer/particle mixture solution 4 comprising a polymer solution containing at least one particle material selected from the group consisting of metal particles, organic particles, inorganic particles, colloidal particles and the like is coated on the base coat layer 3. Then, the polymer/particle mixture solution 4 over the polymer solution 3 is irradiated with light and/or heated. This forming process induces crosslinking polymerization reaction in the polymer/particle mixture solution over the polymer solution, so that the particles are gelated to form a molecular and/or particle assembly layer 6 over the organic layer 5. The organic layer 5 comprises a polymer and polymer/particle mixture. The molecular and/or particle assembly layer 6 serve as a cured layer.

Where the above embodiment employs a substrate formed of a metal, the polymer solution as the base coat may preferably be coated over the substrate by electrodeposition. The polymer/particle mixture solution may preferably be irradiated with UV light rays or electron beams from all directions and/or heated. In the UV radiation, UV rays of different wavelengths are applied.

Now, the following is a description on a case where the substrate 2 is of an aluminum alloy and the molecular assembly layer or particle assembly layer 6 is formed at the uppermost layer. The polymer solution 3 forming the base coat layer is electrodeposited on the substrate 2 of aluminum alloy in thickness of about 15 to 20 μm. The polymer solution 3 is cured by heating in an oven. Next, the polymer/particle mixture solution 4 is coated on the base coat layer. The polymer/particle mixture solution 4 is then exposed to UV rays. This process induces crosslinking polymerization reaction between the polymer solution and the polymer/particle mixture solution.

Specifically, the UV radiation activates a photoinitiator in the material and then affects a prepolymer and a monomer for effecting a polymerization propagation reaction followed by a chain transfer reaction and termination of the crosslinking polymerization. At the start of the propagation reaction, the photoinitiator scattered around colloidal silica and the prepolymer and monomer present in the vicinity thereof are partially cured and polymerized to form local assemblies, which propagates across the layer to terminate the crosslinking polymerization.

A crosslinking polymerization reaction occurs near an interface between the polymer solution as the base coat layer and the polymer/particle mixture solution. Before the scattered local molecular assemblies propagate across the layer to terminate the crosslinking polymerization reaction, the crosslinking polymerization starts from the interface to form a cured assembly. Thus, the molecules continue the crosslinking polymerization reaction driving away foreign substances and mixture substances, thereby pushing up silica, for example, to a layer over the organic material to form a cured layer.

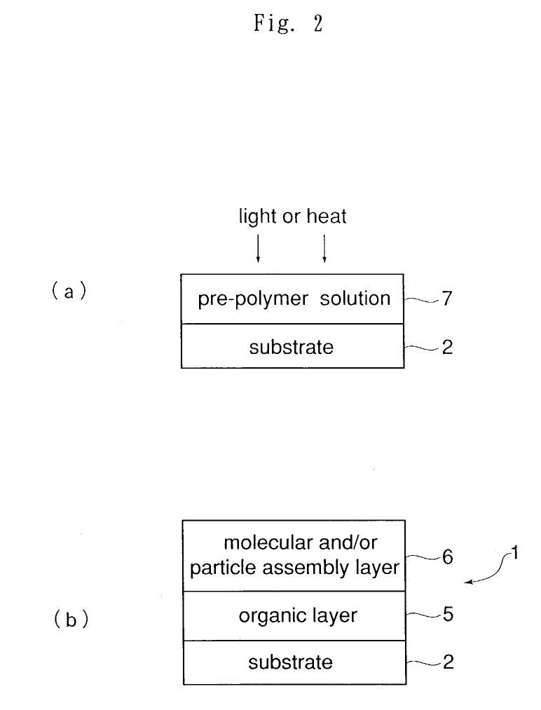

Referring to FIGS. 2A and 2B, the substrate 2 comprises one material selected from the group consisting of metals, ceramics, glass, wood, paper and the like. An organic layer 5 of a polymer and a polymer/particle mixture is formed by coating the substrate 2 with pre-polymer solution 7 containing polymers, monomers, particles and an initiator. A molecular and/or particle assembly layer 6 defining a cured layer is also formed over the organic layer 5 as a result of the exposure of the pre-polymer solution 7 to light and/or heat inducing cross-linking polymerization reaction.

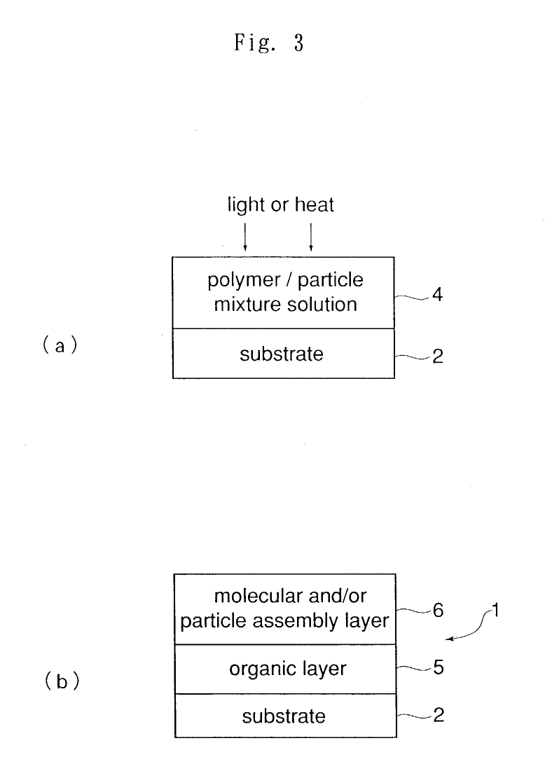

Referring to FIGS. 3A and 3B, procedure of fabricating a thin-film layer is described. This thin-film layer differs from that of FIG. 1 in that a plastic substrate 2 is used so as to dispense with the polymer as the base coat. Therefore, the polymer/particle mixture solution 4 is directly coated on the substrate 2. Subsequently, the polymer/particle mixture solution 4 are irradiated with UV light. The process induces the crosslinking polymerization reaction in the polymer/particle mixture solution 4. Thus, a molecular and/or particle assembly layer 6 is formed over the organic layer 5.

The molecular and/or particle assembly 6 layer comprises a metal oxide, inorganic oxide or amorphous substance. Alternatively, the molecular and/or particle assembly layer comprises SiO₂+C or amorphous silicon. The SiO₂+C layer has a thickness of about 5 μm.

It is also possible to produce in the organic layer 5 a thin-film electronic part, such as thin-film devices including ICs, hybrid ICs and the like; condensers; capacitors; resistors and the like, by exposing the polymer/particle mixture solution to controlled UV rays or electron beams and subjecting the same to a lithographical step in combination.

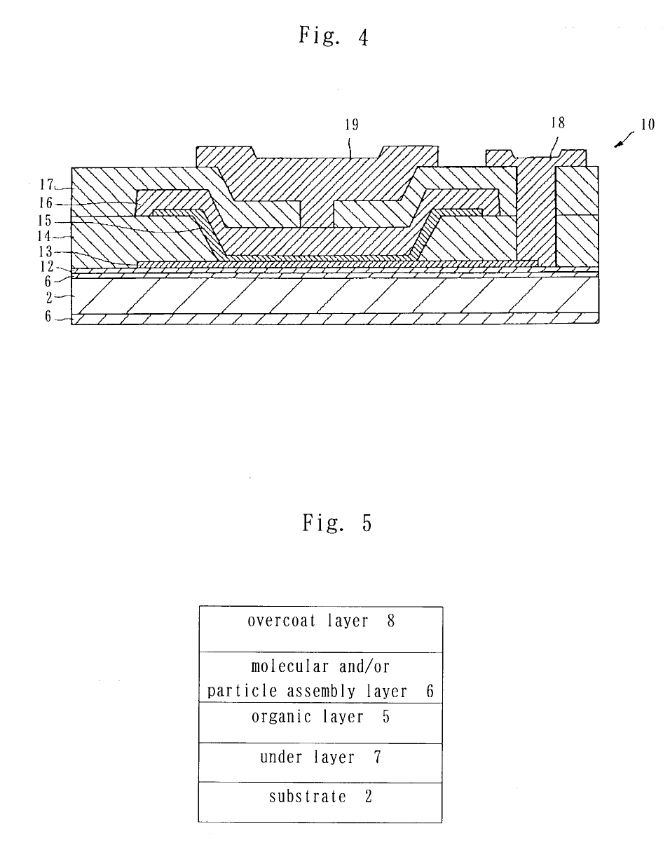

FIG. 4 is a sectional view showing the main portion of an organic EL (Electroluminescence) element in which a flexible metal plate is used for a drive circuit substrate. In FIG. 4, the EL 10 comprises a substrate 2, a gas barrier laminate providing a gas barrier layer 6 with a organic layer 5 on both surfaces of the substrate 2, a electrode 12, a transparent electrode 13,a first insulating layer 14 of SiN acting as a gas barrier, an organic EL element 15,a metal electrode 16,a second insulating layer 17,a first and second electrode 18 and 19.

In the element, a gas barrier laminate provides a gas barrier layer 6 and an organic layer 5 on the substrate. The gas barrier laminate prevents a gas such as hydrogen or oxygen to permeate through the organic EL element, thereby inhibiting the occurrence of deterioration.

The flexible substrate is made of a thin plate of stainless steel, aluminum, iron or nickel having a thickness of 100 μm. On this substrate, a drive circuit for driving the organic EL element is formed. It is to be noted that the substrate may be made of one material selected from the group consisting of ceramics, glass, wood and the like, in addition to the above metals.

The gas barrier layer 6 and an organic layer 5 are explained in FIGS. 1, 2 and 3. An organic layer 5 of a polymer and a polymer/particle mixture on the substrate is formed by coating the substrate with the polymer solution 3 based on one resin selected from the group consisting of acrylic resins, urethane resins, epoxy resins and the like. Onto the polymer solution 3, the polymer/particle mixture solution 4 containing therein at least one particle material selected from the group consisting of metal particles, organic particles, inorganic particles, colloidal particles and the like is applied. The polymer/particle mixture solution is exposed by light and/or heat.

A pre-polymer solution containing polymers, monomers, particles and an initiator may be coated on the substrate.

Over the organic layer 5, a plurality of molecular and/or particle assembly layers acting as gas barrier layer is defined a cured layer formed as a result of the exposure of the polymer/particle mixture solution to light and/or heat inducing crosslinking polymerization reaction in the polymer/particle mixture solution over the polymer solution for gelating the particles. The assembly layers comprise at least one layer selected from the group consisting of non-particle layer, layer containing one particle and layer containing a plurality of different particles.

A cured layer 6 formed over the organic layer 5 as a result of the exposure of the pre-polymer solution 7 to light and/or heat inducing cross-linking polymerization reaction is may be defined. The cured layer is defined as the molecular and/or particle assembly layer and comprises at least one layer selected from the group consisting of non-particle layer, layer containing one particle and layer containing a plurality of different particles.

The molecular and/or particle assembly layer comprises the one or more different molecular and/or particle formed by at least one particle selected from the group consisting of specific gravity of particle, size of particle, surface properties such as wettability or surface tension in the interface of polymer with particle, orientation of particle, interaction between particles, charge action of particle, migration by light irradiation such as UV light and/or heat of particle.

The gas barrier laminate can be utilized in en electronic device such as a touch panel, a FPD, a semiconductor or an electronic paper.

FIG. 5 is a sectional view schematically showing a gas barrier laminate for package which is used in package fields of food, medicine and non-food such as electronic parts. This laminate has high gas barrier properties, and inhibits the permeation of oxygen or water vapor in the atmosphere, thereby controlling the deterioration and transformation of contents contained in a package by this laminate.

The gas barrier laminate is constituted by laminating an under layer 7 on one surface or both surfaces of a substrate 2 made of a plastic material, a gas barrier layer 6 thereon, and a protective layer 8 thereon.

Examples of usable materials for the substrate 2 include a polyester film of polyethylene terephthalate, polyethylene naphthalate or the like, a polyolefin film of polyethylene, polypropylene or the like, a polystyrene film, a polyamide film of 66-nylon or the like, a polycarbonate film, and a polyimide film. These films preferably have extensibility, transparency, mechanical strength and dimensional stability.

The under layer 7 is formed to improve wettability, uniform film formation properties and adhesive properties of the gas barrier layer 3 formed on the substrate 2, and to thereby express excellent gas barrier properties. An organic layer of a polymer and a polymer/particle mixture is formed by coating with polymer/particle mixture solution applied over the substrate, the mixture solution containing therein at least one particle selected from the group consisting of metal particles, organic particles, inorganic particles, colloidal particles and the like.

The gas barrier layer 6 is comprises a plurality of molecular and/or particle assembly layers defining a cured layer formed over an organic layer as a result of the exposure of the polymer/particle mixture solution to light and/or heat inducing crosslinking polymerization reaction in the mixture for gelating the particles wherein the assembly layers comprise at least one layer selected from the group consisting of non-particle layer, layer containing one particle and layer containing a plurality of different particles. It is to be noted that it is preferred that the gas barrier layer contains used at least one of a nitrogen compound, a water-soluble polymer and an organic silicon compound for the sake of further improving film formation properties, flexibility and wettability. Examples of the nitrogen compound include ammonia, halogenated amines, metallic amides, metallic amides, inorganic salts such as ammonium salts and nitrates, and cyanic compounds. The thickness of the gas barrier layer 3 is in a range of 0.005 to 5 μm, preferably 0.01 to 1 μm.

The molecular and/or particle assembly layer is defined a cured layer with the one or more different molecular and/or particle is formed by at least one particle selected from the group consisting of specific gravity of particle, size of particle, surface properties such as wettability or surface tension in the interface of polymer with particle, orientation of particle, interaction between particles, charge action of particle, migration by light irradiation such as UV light and/or heat of particle.

On the gas barrier layer, an overcoat layer 8 is formed. When as the overcoat layer, for example, a coating layer comprising a metal alkoxide and a water-soluble resin is applied, a gas barrier properties and water vapor barrier properties are further improved. Preferable examples of the metal alkoxide include tetraisoproxy silane and triisopropoxy aluminum, and preferable examples of the water-soluble resin include polyvinyl alcohol and methyl cellulose.

The gas barrier laminate provides a protective characteristic to provide a hight hardness. The a protective layer is used one parts or device selected from the group consisting of a wheel, a bicycle, an electric paper, a touch panel, a FPD, an optical disc, an IC tag, a mobile telephone, a computer housing, furniture, a musical instrument, a tableware, an ornament, a print circuit board, a semiconductor device, and a sports goods.

To apply the above-mentioned under layer, gas barrier layer and protective layer, a usual coating technique can be used. On the substrate made of a plastic material, the base layer, the gas barrier layer and the protective layer are applied/laminated, and they are then irradiated with ultraviolet light. It is to be noted that the size of the particles is on the order to nanometer. The particle provides a conductive characteristic or dye characteristic.

The gas barrier layer 6 provides preferably a plurality of molecular and/or particle assembly layers, but may be a single molecular and/or particle assembly layer.

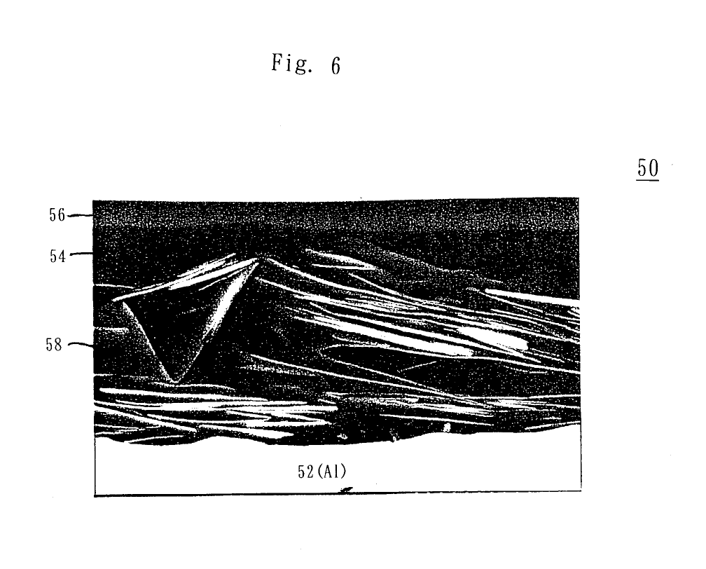

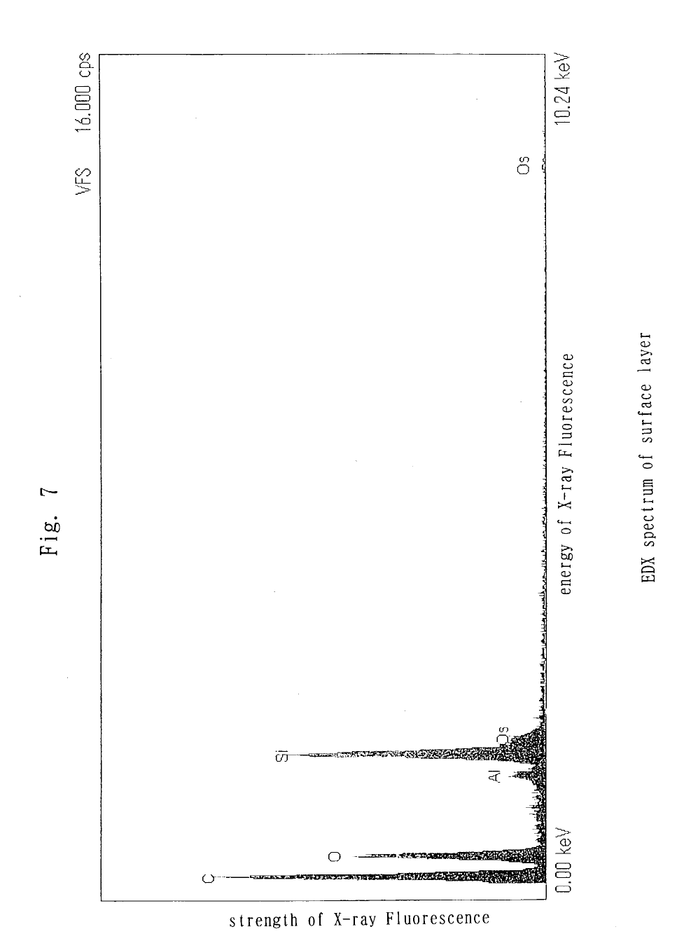

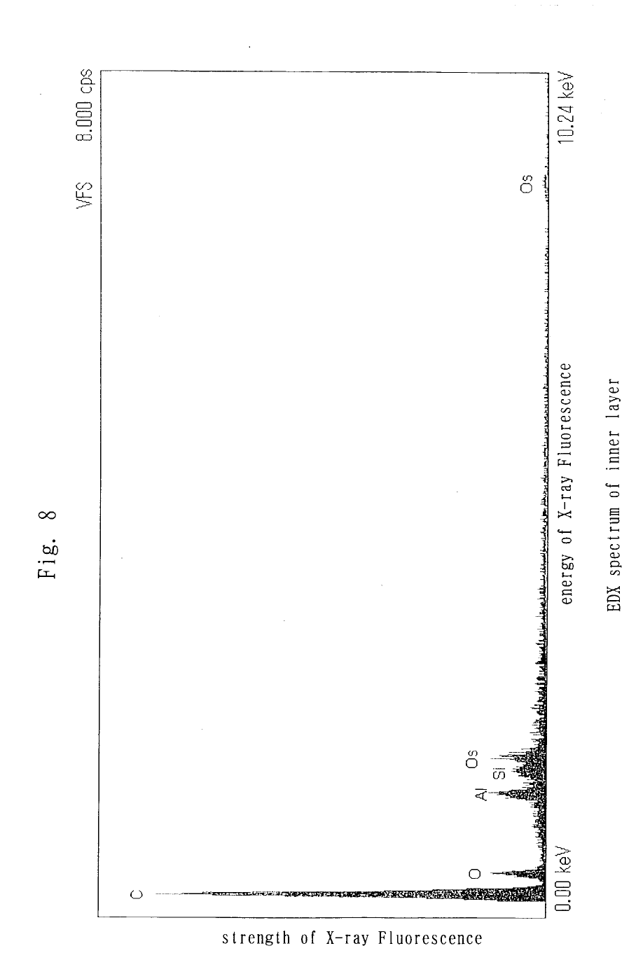

FIG. 6 is a sectional view showing a condition in which a thin-film layer regarding the present invention is deposited on an aluminum wheel attached to a tire of an automobile. Analysis and observation were carried out by an energy dispersion type X-ray analysis device (EDX) made by Horiba Seisakusho Co., Ltd. and a free electron type scanning electron microscope (FE-SEM) made by Hitachi, Ltd., respectively. In this drawing, a thin-film layer 50 comprises an inner layer 54 of about 20 (m formed on a matrix 52 of an aluminum material and a surface layer 56 of about 2 to 3 ìm formed on this inner layer 54. An acrylic resin constituting the inner layer 54 and the surface layer 56 contains elements of carbon (C), oxygen (O) and silicon (Si). Therefore, in the acrylic resin of the surface layer 56, silicon dioxide (SiO) and carbon (C) are present together. Furthermore, a strength relation between the above-mentioned elements in the inner layer is C>>O=Si (FIG. 7), and a strength relation between the above-mentioned elements in the surface layer is C=Si>O (FIG. 8).

When aluminum as an additive is mixed within the polymer/particle mixture solution on the polymer solution, or a pre-polymer solution, fibrous substances 58 of aluminum as an additive exist in the solution at the vicinity of the matrix.

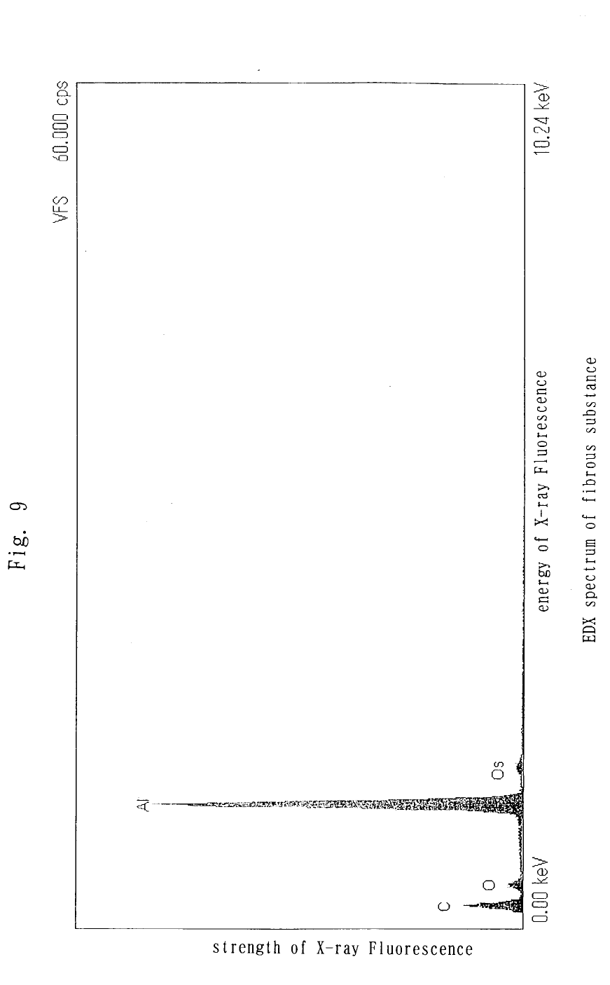

In addition, in the inner layer, The fibrous substance 58 has a length of 10 and several ìm and a thickness of about 1 ìm. The fibrous substance contains elements of carbon (C), oxygen (O) and aluminum (Al). A strength relation between the above-mentioned elements in the fibrous substance is Al>C>O (FIG. 9).

Here, the surface layer has high hardness, excellent adhesive properties, heat resistance and chemical resistance. The hardness was 3H or more as measured by a lead hardness tester. The heat resistance was evaluated by a surface combustion method (temperature of flames during heating: about 1000(C) using a burner, and a change from a transparent state to a light brown was confirmed after about 1 minute and 29 seconds from the start of the heating. The chemical resistance was evaluated by holding each of a 10% hydrochloric acid solution, a 10% sulfuric acid solution and a 10% nitric acid solution on the surface layer for about 30 minutes, and then observing an appearance of the surface layer after the removal of the reagent.

The formation of the thin-film layer on the aluminum wheel was carried out under the following conditions by the use of a thin-film deposit forming device shown in FIG. 7. An acrylic solution was applied onto the aluminum wheel, and then an (SiO+C)-containing acrylic solution was applied thereon. While being in this state, the thin-film layer was heated at 155(F. to 185(F., and then irradiated with an ultraviolet ray having a wavelength of 250 nm to 360 nm. At this time, an energy per unit area of the thin-film layer is at least 75 mJ/cm2.

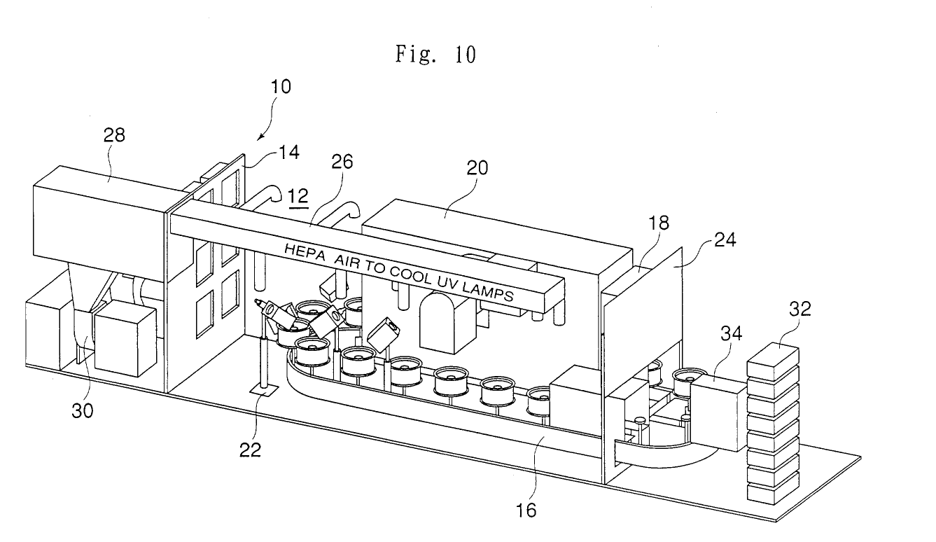

FIG. 10 schematically shows a fabrication apparatus for fabricating the thin-film layer. Referring to the figure, the thin-film layer fabrication apparatus 10 comprises a chamber 12 and a filter 14 for preventing the entrance of dusts and foreign substances into the chamber. The chamber 12 includes a conveyor system 16 for conveying the substrates; a coating applicator 18 for coating each substrate with a polymer solution as a base coat layer which is based on at least one resin selected from the group consisting of acrylic resins, urethane resins and epoxy resins, and then applying, onto each base coat layer, a polymer/particle mixture solution comprising a polymer solution containing therein at least one particle selected from the group consisting of metal particles, organic particles, inorganic particles, colloidal particles and the like ; a heating chamber 20 heated to 155(F. to 185(F. for heat curing the polymer solution thus applied; and a light/heat source 22 for exposing the polymer/particle mixture solution over the base coat layer to light rays of same or different wavelengths or heat from all directions, the polymer/particle mixture solution containing therein at least one particle selected from the group consisting of metal particles, organic particles, inorganic particles, colloidal particles and the like.

The chamber is enclosed by divider walls 24 except for a place where the filter 14 is installed. The light/heat source 22 may be a UV irradiation apparatus, electron beam irradiation apparatus or heating apparatus. The UV irradiation apparatus emits UV light rays of same or different wavelengths of 250 nm to 360 nm. The energy per unit area of the thin-film layer being at least 75 mJ/cm2. The fabrication system may further comprise a UV lamp adjustable device for permitting UV lamps of the UV irradiation apparatus to be inclined at predetermined angles The fabrication system may further comprise a cooling system 26 which is disposed at a position above the UV irradiation apparatus 22 for air cooling the same. The cooling system 26 includes a filter 28 for cooling air and a cooling blower 30 for discharging the cooling air, which are disposed outside of the chamber. The chamber may be further provided with an inert gas supply for introducing an inert gas thereinto.

1. A thin-film layer comprising:
a substrate comprising one material selected from the group consisting of metals, ceramics, glass, wood, paper and the like;
an organic layer of a polymer and a polymer/particle mixture formed by coating the substrate with the polymer solution based on one resin selected from the group consisting of acrylic resins, urethane resins, epoxy resins and the like, and further applying, onto the polymer solution, the polymer/particle mixture solution containing therein at least one particle material selected from the group consisting of metal particles, organic particles, inorganic particles, colloidal particles and the like, followed by exposing the polymer/particle mixture solution to light and/or heat; and
a molecular and/or particle assembly layer defining a cured layer formed over the organic layer as a result of the exposure of the polymer/particle mixture solution to light and/or heat inducing crosslinking polymerization reaction in the polymer/particle mixture solution over the polymer solution for gelating the particles.

2. A thin-film layer comprising:
a substrate comprising one material selected from the group consisting of metals, ceramics, glass, wood, paper and the like;
an organic layer of a polymer and a polymer/particle mixture formed by coating the substrate with a pre-polymer solution containing polymers, monomers, particles and an initiator; and
a molecular and/or particle assembly layer defining a cured layer formed over the organic layer as a result of the exposure of the pre-polymer solution to light and/or heat inducing cross-linking polymerization reaction.

3. A thin-film layer comprising:
a plastic substrate;
an organic layer of a polymer and a polymer/particle mixture formed by coating the substrate with polymer/particle mixture solution applied over the substrate, the mixture solution containing therein at least one particle selected from the group consisting of metal particles, organic particles, inorganic particles, colloidal particles and the like; and
a molecular and/or particle assembly layer defining a cured layer formed over an organic layer as a result of the exposure of the polymer/particle mixture solution to light and/or heat inducing crosslinking polymerization reaction in the mixture for gelating the particles.

4. A thin-film layer according to claims 1,2 or 3, wherein the light is UV light or electron beam.

5. A thin-film layer according to claim 4, wherein the light is irradiated by UV light rays of different wavelengths.

6. A thin-film layer according to claim 2 or 3, wherein the polymer solution is electrodeposited on the substrate.

7. A thin-film layer according to claim 2 or 3, wherein the molecular and/or particle assembly layer comprises a metal oxide, inorganic oxide or amorphous substance.

8. A thin-film layer according to claim 7, wherein the molecular and/or particle assembly layer comprises SiO₂ or amorphous silicon.

9. A thin-film device comprising the thin-film layer according to claim 1 ,2 or 3.

10. A thin-film layer comprising:
A thin-film layer comprises an surface layer comprising a mixture of a silicon dioxide and a resin such as an acrylic resin of 2˜3 μm, the surface layer containing elements of carbon (C), oxygen (O) and silicon (Si), a strength relation between the elements in the surface layer being C=Si>O;
an inner layer comprising a resin such as an acrylic resin of several tens μm formed on a matrix of a metallic material such as aluminum, the inner layer containing elements of carbon (C), oxygen (O), silicon (Si), a strength relation between the elements being C>>O =Si.

11. A thin-film layer comprises an surface layer comprising a mixture of a silicon dioxide and a resin such as an acrylic resin of 2˜3 μm, the surface layer containing elements of carbon (C), oxygen (O) and silicon (Si), a strength relation between the elements in the surface layer being C=Si>O;
an inner layer comprising a resin such as an acrylic resin of several tens μm formed on a matrix of a metallic material such as aluminum, the inner layer containing elements of carbon (C), oxygen (O), silicon (Si), a strength relation between the elements being C>>O=Si; and
a fibrous substance being in the vicinity of the matrix in the inner layer, the fibrous substance having a length of several tens μm and a thickness of several μm and containing elements of carbon (C), oxygen (O) and an additive of a metal, a strength relation between the respective elements being the element of additive of metal>C>O.

12. A method for forming a thin-film layer which comprises the steps of applying a polymer solution onto a metallic substrate of aluminum or the like, and then applying a polymer/particle mixture solution thereon,
wherein the thin-film layer after the application is heated to 155 F.° to 185 F.°, and then irradiated with an ultraviolet ray having a wavelength of 250 nm to 360 nm, an energy per unit area of the thin-film layer being at least 75 mJ/cm2.

13. A gas barrier laminate or a protective laminate comprising;
an organic layer of a polymer and a polymer/particle mixture formed by coating the substrate with the polymer solution based on one resin selected from the group consisting of acrylic resins, urethane resins, epoxy resins and the like, and further applying, onto the polymer solution, the polymer/particle mixture solution containing therein at least one particle material selected from the group consisting of metal particles, organic particles, inorganic particles, colloidal particles and the like, followed by exposing the polymer/particle mixture solution to light and/or heat; and
a plurality of molecular and/or particle assembly layers defining a cured surface layer formed over the organic layer as a result of the exposure of the polymer/particle mixture solution to light and/or heat inducing crosslinking polymerization reaction in the polymer/particle mixture solution over the polymer solution for gelating the particles, wherein the assembly layers comprising at least one layer selected from the group consisting of non-particle layer, layer containing one particle and layer containing a plurality of different particles.

14. A gas barrier laminate or a protective laminate comprising:
an organic layer of a polymer and a polymer/particle mixture formed by coating the substrate with a pre-polymer solution containing polymers, monomers, particles and an initiator; and
a plurality of molecular and/or particle assembly layers defining a cured layer formed over the organic layer as a result of the exposure of the pre-polymer solution to light and/or heat inducing cross-linking polymerization reaction, wherein the assembly layers comprising at least one layer selected from the group consisting of non-particle layer, layer containing one particle and layer containing a plurality of different particles.

15. A gas barrier laminate or a protective laminate comprising:
an organic layer of a polymer and a polymer/particle mixture formed by coating the substrate with polymer/particle mixture solution applied over the substrate, the mixture solution containing therein at least one particle selected from the group consisting of metal particles, organic particles, inorganic particles, colloidal particles and the like; and
a plurality of molecular and/or particle assembly layers defining a cured layer formed over an organic layer as a result of the exposure of the polymer/particle mixture solution to light and/or heat inducing crosslinking polymerization reaction in the mixture for gelating the particles, wherein the assembly layers comprising at least one layer selected from the group consisting of non-particle layer, layer containing one particle and layer containing a plurality of different particles.

16. A gas barrier laminate or a protective laminate according to claims 13,14 or 15, wherein the molecular and/or particle assembly layer defining a cured layer with the one or more different molecular and/or particle formed by at least one particle selected from the group consisting of specific gravity of particle, size of particle, surface properties such as wettability or surface tension in the interface of polymer with particle, orientation of particle, interaction between particles, charge action of particle, migration by light irradiation such as UV light and/or heat of particle.

17. A gas barrier laminate or a protective laminate according to claims 16, wherein the size of particle is order of nanometer.

18. A gas barrier laminate or a protective laminate according to claims 16, wherein the particle provides a conductive characteristic or dye characteristic.

19. A gas barrier laminate or a protective laminate according to claims 13,14 or 15 for used one parts or device selected from the group consisting of a wheel, a bicycle, an electric paper, a touch panel, a FPD, an optical disc, an IC tag, a mobile telephone, a computer housing, furniture, a musical instrument, a tableware, an ornament, a print circuit board, a semiconductor device, a sports goods and an electronic paper.

20. A thin-film layer fabrication apparatus comprising:
a chamber including a conveyor system for conveying a substrate,
a coating applicator for applying, onto the substrate, a polymer solution based on one resin selected from the group consisting of acrylic resins, urethane resins, epoxy resins and the like, and
a light/heat source for exposing a polymer/particle mixture solution to light and/or heat, the polymer/particle mixture solution comprising the polymer containing therein at least one particle selected from the group consisting of metal particles, organic particles, inorganic particles, colloidal particles and the like; and
a filter for preventing the entrance of dusts and foreign substances into the chamber.

21. A thin-film layer fabrication apparatus according to claim 20, wherein the light/heat source is a UV irradiation apparatus, electron beam irradiation apparatus or heat source.

22. A thin-film layer fabrication apparatus according to claim 21, wherein the UV irradiation apparatus emits UV light rays of different wavelengths.

23. A thin-film layer fabrication apparatus according to claim 20, further comprising an adjustable UV lamp device for permitting a UV lamp of the UV irradiation apparatus to be inclined at a predetermined angle.

24. A thin-film layer fabrication apparatus according to claim 20, further comprising a cooling system for cooling the UV irradiation apparatus.

25. A thin-film layer fabrication apparatus according to claim 20, further comprising an inert gas supply for introducing an inert gas into the chamber.
